(19) United States
(12) Patent Application Publication
(10) Pub. No.: US 2009/0095319 A1
(43) Pub. Date: Apr. 16, 2009

(54) FLOSSER PICK SYSTEM

(76) Inventors: John M. Jansheski, Maryville, TN (US); Lex Shankle, Maryville, TN (US); Eric Mowell, Maryville, TN (US); Devin Moore, Decatur, GA (US); Erick E. Rios, Decatur, GA (US); Collin Farill, Decatur, GA (US)

Correspondence Address: LUEDEKA, NEELY & GRAHAM, P.C., P O BOX 1871, KNOXVILLE, TN, 37901, US

(21) Appl. No.: 11/872,753

(22) Filed: Oct. 16, 2007

(51) Int. Cl. A61C 15/04; A61C 15/02; A61C 15/00

(52) U.S. Cl. 132/323; 132/328; 132/329; 132/321

(57) ABSTRACT

A flosser pick system, having a first dental flosser having an elongate handle with a pick end and a second dental flosser having a handle, a pair of spaced apart arms at one end of the handle with a length of dental floss extending between the arms, and a receiver defined as part of second dental flosser and configured to matingly receive portions of the first flosser to provide the flosser pick system.

### FIELD

This disclosure relates to the field of dental flossing devices. More particularly, this disclosure relates to a combination flosser/pick device which is configured to selectively conceal the pick device.

### BACKGROUND

Disposable flossers and tooth picks are popular dental cleaning devices. The disclosure relates to improvements in the use of flossers, particularly disposable flossers, by providing a system which provides a plurality of flossing devices in combination with a dental pick device in a compact configuration.

### SUMMARY

The above and other needs are met by flosser pick system that provides a compact configuration.

In a preferred embodiment, the system includes first and second dental flossers. The first flosser includes an elongate handle having a pick end and spaced apart arms at the opposite end with a length of dental floss extending between the arms. The second flosser includes a handle, a pair of spaced apart arms at one end of the handle with a length of dental floss extending between the arms, and a receiver defined as part of second dental flosser and configured to matingly receive portions of the first flosser to provide the flosser pick system.

In one embodiment, the receiver is a cavity provided by a hollow interior portion within the handle of the second dental flosser. The pick end and a portion of the handle of the first dental flosser adjacent the pick end are fittingly insertable into the cavity via the open end of the handle of the second dental flosser.

In another embodiment, the receiver is provided by a pair of spaced apart legs defined on the second flosser. The legs have inwardly facing protrusions configured for frictionally engaging portions of the first flosser.

In yet another embodiment, the receiver is provided by an elongate concavity formed on a surface of the handle of the second flosser.

In a further embodiment, the receiver is provided by an elongate aperture defined adjacent the handle of the second flosser and configured to permit the pick end of the first flosser to be passed therethrough and frictionally engage an adjacent portion of the handle of the first flosser.

Each of the flossers of the system may be used individually, or in the assembled state so as to facilitate their use by providing increased handle lengths.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a perspective view of an assembled flosser pick system according to an embodiment of the disclosure.

FIG. 2 is an exploded view of the flosser pick system of FIG. 1.

FIG. 3 shows an alternate embodiment of a flosser having a pick end for use with the system of FIG. 1.

FIG. 4 is a perspective view of an assembled flosser pick system according to another embodiment of the disclosure, and FIG. 5 is an exploded view thereof.

FIG. 6 is a top view of an assembled flosser pick system according to yet another embodiment of the disclosure, and FIG. 7 is a side view thereof.

FIG. 8 is a top view of an assembled flosser pick system according to a further embodiment of the disclosure, and FIG. 9 is a side view thereof.

FIG. 10 shows a flosser of the system of FIGS. 8 and 9.

FIG. 11 is a top view of an assembled flosser pick system according to another embodiment of the disclosure, and FIG. 12 is an exploded view thereof.

FIG. 13 is a top view of an assembled flosser pick system according to still another embodiment of the disclosure, and FIG. 14 is an exploded view thereof.

### DETAILED DESCRIPTION

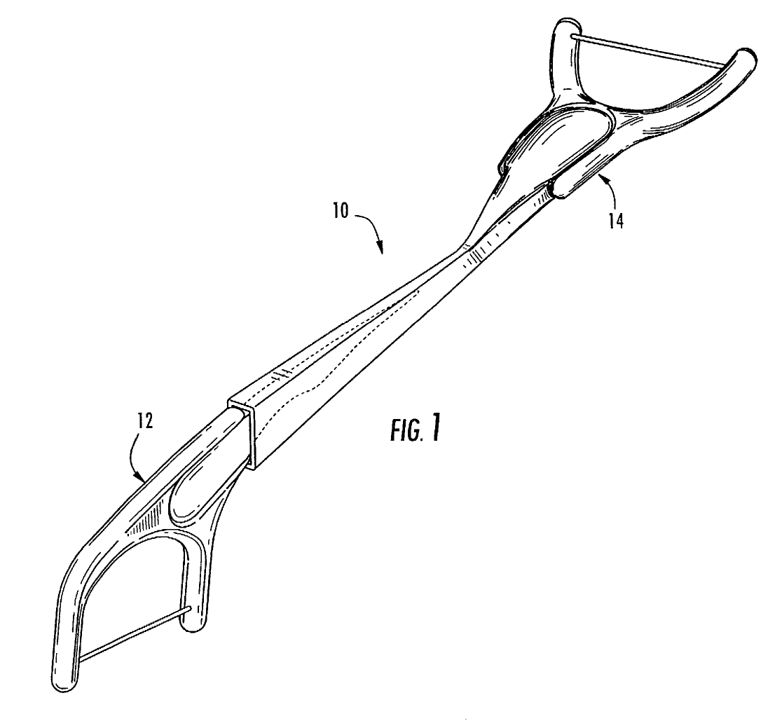

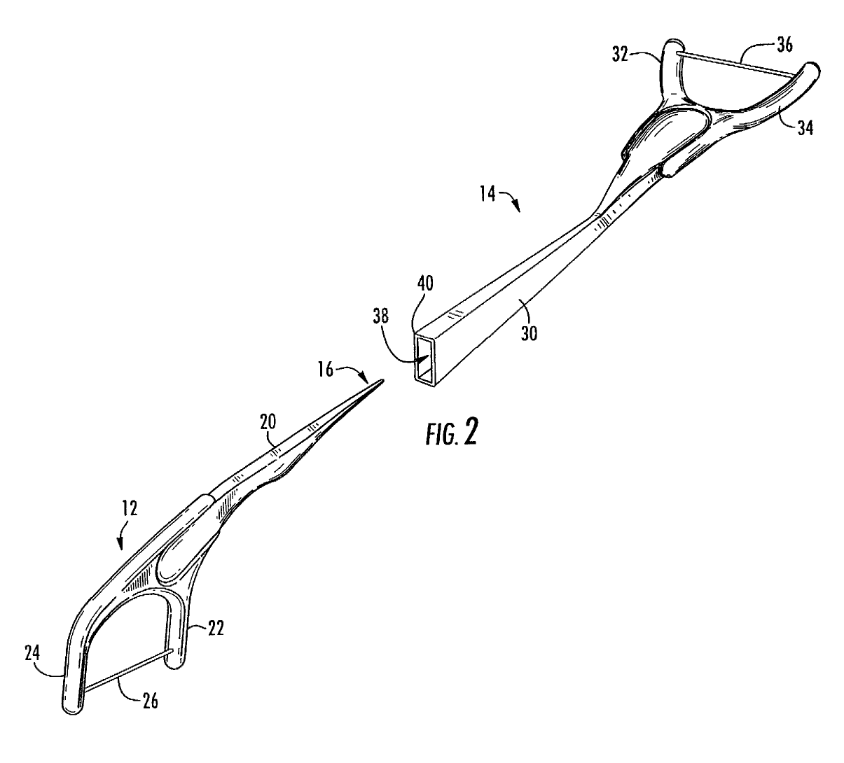

With initial reference to FIG. 1, the disclosure relates to a combination flosser pick system 10 having a first flosser 12 and a second flosser 14. The first flosser 12 is configured to include a pick end 16. The second flosser 14 is configured to matingly receive the pick end 16 of the first flosser 12 to provide the assembled flosser/pick system 10.

The first flosser 12 and the second flosser 14 may each be used with the system 10 in the assembled state, with the effective handle length for each flosser being effectively increased by the presence of the other flosser of the assembled system 10. The system 10 may also be disassembled for individual use of either flosser, or of the pick end 16 of the flosser 12. Each of the flossers 12 and 14 are desirably configured for different portions of the mouth. For example, the first flosser may be configured to better facilitate cleaning of frontal teeth and the second flosser may be configured to better facilitate cleaning of rear teeth.

The first flosser 12 may be a molded plastic disposable flosser having an elongate handle 20 for grasping by a user. The handle 20 is configured to define the pick end 16. In one embodiment, the pick end 16 is tapered to a point to correspond to a toothpick structure. The pick end 16 may also be textured to facilitate cleaning. Spaced apart arms 22 and 24 are defined at the opposite head end of the handle 20. A length of dental floss 26 is secured to and extends between the arms 22 and 24.

The second flosser 14 may be a molded plastic disposable flosser having an elongate handle 30. The handle 30 includes spaced apart arms 32 and 34 defined at a head end of the handle 30. A length of dental floss 36 is secured to and extends between the arms 32 and 34. An interior portion of the handle 30 is hollow to define a cavity 38. The cavity 38 is accessible via an open end 40 of the handle 30 located opposite the arms 32 and 34. The cavity 38 provides a receiver configured to fittingly receive the pick end 16 and a portion of the handle 20 of the first flosser 12. It is desirable to make the second flosser 14 out of a translucent plastic material so that the pick end 16 is visible in the assembled system 10.

It will be appreciated that the configuration of the first flosser 12 in the assembled system 10 further facilitates use of the second flosser 14 on rear teeth by effectively providing an extension of the handle 30 of the second flosser 14 which enables a user to more easily reach locations of back teeth. Likewise, the use of the first flosser 12 may likewise be facilitated by the additional effective handle length provided by the second flosser 14.

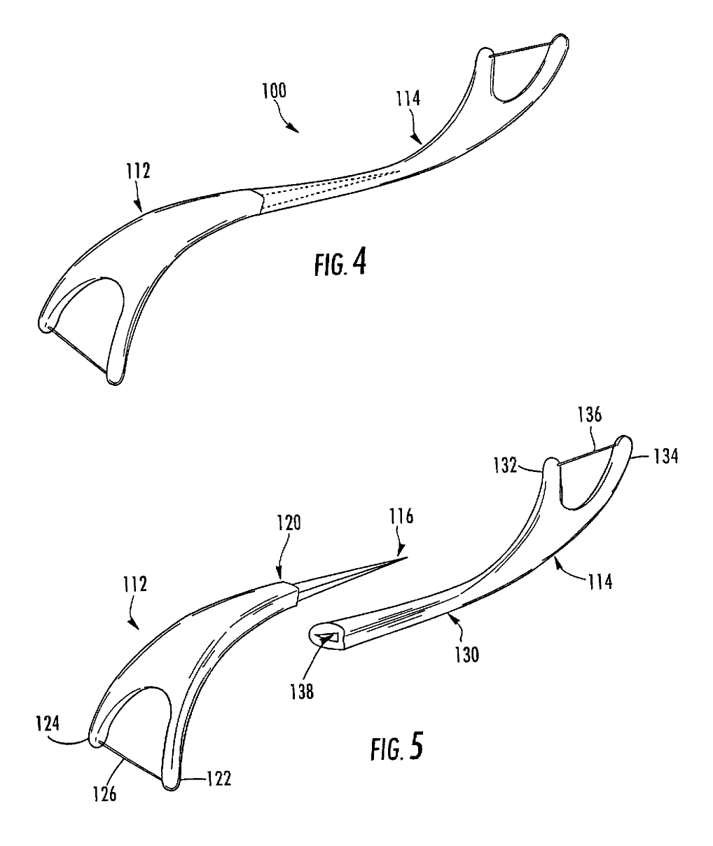

In an alternate embodiment, the pick end may be otherwise configured as a relatively elongate tooth cleaning structure for fitting between interstices of the teeth. For example, with reference to FIG. 3, the pick end 16 is configured to include an interdental brush 42. Alternate elongate tooth cleaning structures include rubber tips, dental scalers, and the like.

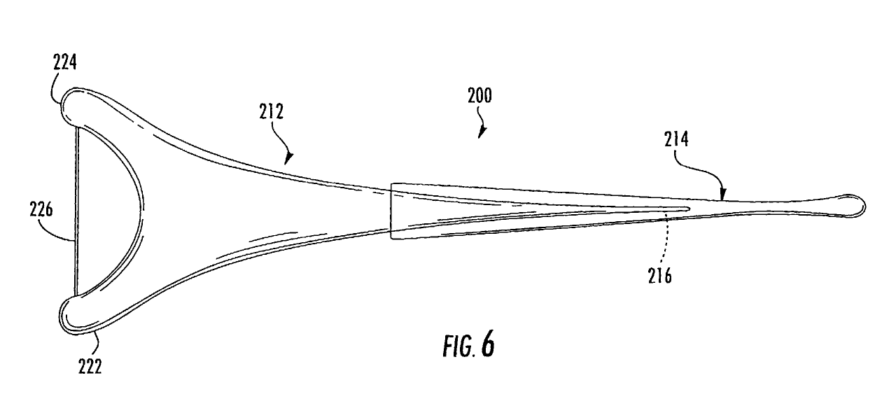

With reference to FIGS. 4 and 5, there is shown another embodiment of a combination flosser pick system 100 having a first flosser 112 and a second flosser 114. The first flosser 12 is configured to include a pick end 116. The second flosser 114 is configured to matingly receive the pick end 116 of the first flosser 112 to provide the assembled flosser/pick system 100.

The first flosser 112 includes an elongate handle 120, spaced apart arms 122 and 124, with a length of dental floss 126 is secured to and extends between the arms 122 and 124. The second flosser 114 includes an elongate handle 130 having spaced apart arms 132 and 134. A length of dental floss 136 is secured to and extends between the arms 132 and 134. An interior portion of the handle 130 is hollow to define a cavity 138 which provides a receiver configured to fittingly receive the pick end 116 and a portion of the handle 120 of the first flosser 112.

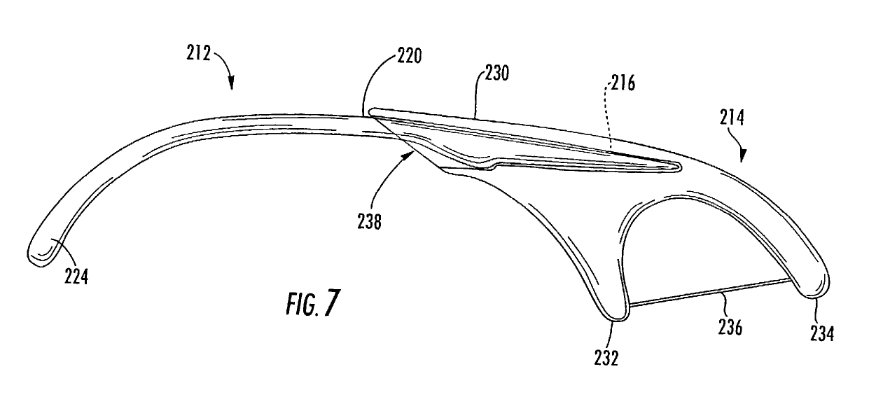

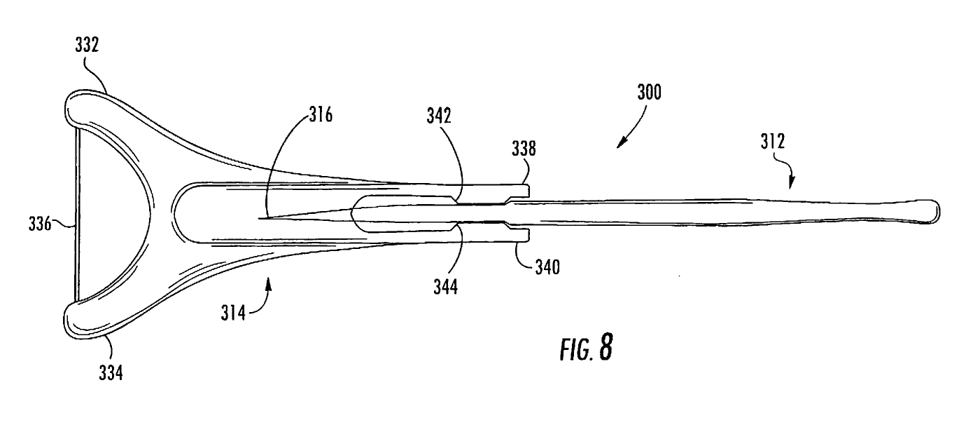

With reference to FIGS. 6 and 7, there is shown yet another embodiment of a combination flosser pick system 200 having a first flosser 212 and a second flosser 214. The first flosser 212 is configured to include a pick end 216. The second flosser 214 is configured to matingly receive the pick end 216 of the first flosser 212 to provide the assembled flosser/pick system 200.

The first flosser 212 includes an elongate handle 220, spaced apart arms 222 and 224, with a length of dental floss 226 is secured to and extends between the arms 222 and 224. The second flosser 214 includes an elongate handle 230 having spaced apart arms 232 and 234, with a length of dental floss 236 is secured to and extends between the arms 232 and 234. An interior portion of the handle 230 is hollow to define a cavity 238 which provides a receiver configured to fittingly receive the pick end 216 and a portion of the handle 220 of the first flosser 212. As best seen in FIG. 7, the cavity 238 and the pick end 216 each include mating offsets for facilitating seating of the pick end 216 within the cavity 238. The second flosser 212 is preferably made of a translucent plastic 10 material to allow the user to see the pick end 216 within the cavity 238.

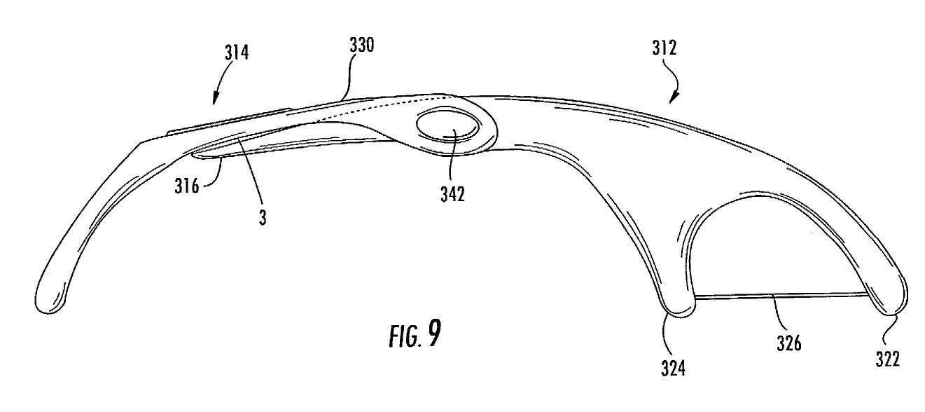

With reference to FIGS. 8-10, there is shown yet another embodiment of a combination flosser pick system 300 having a first flosser 312 and a second flosser 314. The first flosser 312 is configured to include a pick end 316. The second flosser 314 is configured to matingly receive the first flosser 312 to provide the assembled flosser/pick system 300.

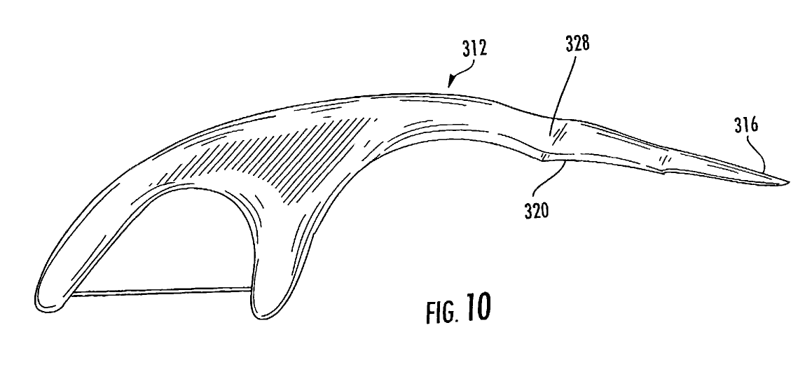

The first flosser 312 includes an elongate handle 320, spaced apart arms 322 and 324, with a length of dental floss 326 is secured to and extends between the arms 322 and 324. The handle 320 includes indents or concave portions 328 on opposite sides of the handle 320 (FIG. 10).

The second flosser 314 includes a handle 330 having spaced apart arms 332 and 334, with a length of dental floss 336 is secured to and extends between the arms 332 and 334. The end of the handle 330 opposite the arms 332 and 334 includes angled and spaced apart legs 338 and 340, having inwardly facing protrusions, such as bumps 342 and 344, respectively. The bumps 342 and 344 are configured for frictionally engaging 25 the concave portions 328 of the handle 320 when the first flosser 312 is installed on the second flosser 314, as shown in FIGS. 8 and 9, to frictionally retain the first flosser 312. Thus, the legs 338/340 and the associated bumps 342/344 provide a receiver configured to fittingly receive portions of the first flosser 312.

To assemble the system 300, the pick end 316 of the first flosser 312 may be slidably inserted between the legs 338 and 340 of the second flosser 314, such that the pick end 316 resides adjacent a lower surface 346 of the handle 330 and the bumps 342 and 344 engage the concave portions 328 to frictionally retain the first flosser 312 in mating engagement with the second flosser 314. The second flosser 312 is preferably made of a translucent plastic material to allow the user to see the pick end 316 when the first flosser 312 is mated with the second flosser 314.

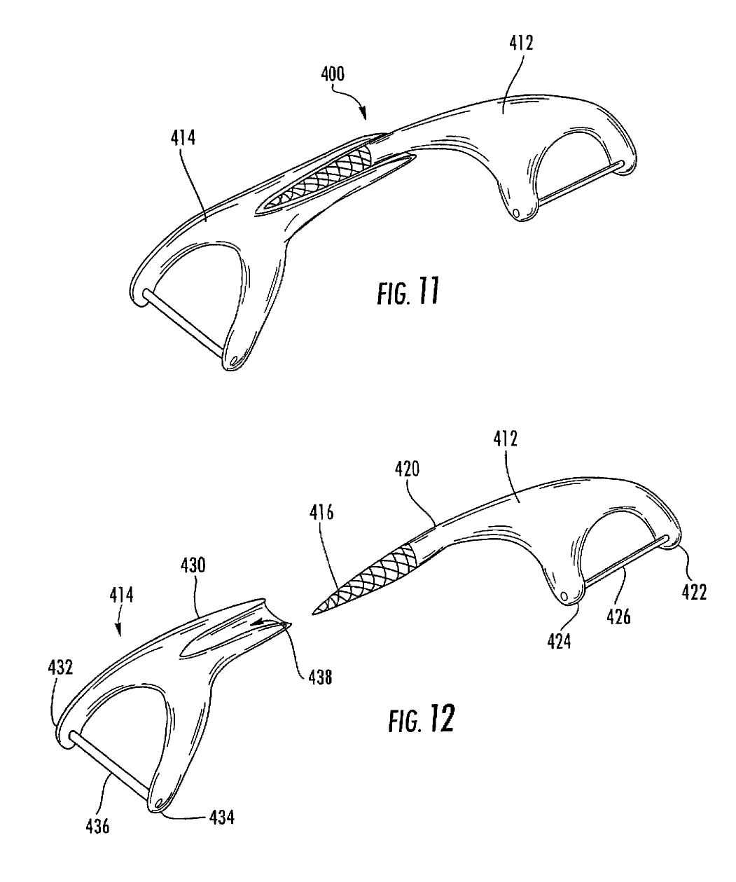

With reference to FIGS. 11 and 12, there is shown another embodiment of a combination flosser pick system 400 having a first flosser 412 and a second flosser 414. The first flosser 412 is configured to include a pick end 416. The second flosser 414 is configured to matingly receive the pick end 416 and associated handle portions of the first flosser 412 to provide the assembled flosser/pick system 400.

The first flosser 412 includes an elongate handle 420, spaced apart arms 422 and 424, with a length of dental floss 426 is secured to and extends between the arms 422 and 424. The second flosser 414 includes a handle 430 having spaced apart arms 432 and 434. A length of dental floss 436 is secured to and extends between the arms 432 and 434. The handle 430 is relatively wide and has a flattened profile to provide a relatively large gripping surface for grasping by a user. An upper surface of the handle 430 is contoured to provide an elongate concavity 438 configured to provide a receiver which fittingly receives the pick end 416 and a portion of the handle 420 of the first flosser 412. That is, the concavity 438 is substantially configured to the shape of the pick end 416 and of the portion of the handle 420 received therein so as to provide a snap-fit relationship. Alternatively, the concavity 438 is configured to enable the pick end 416 and handle portion to be slidably received.

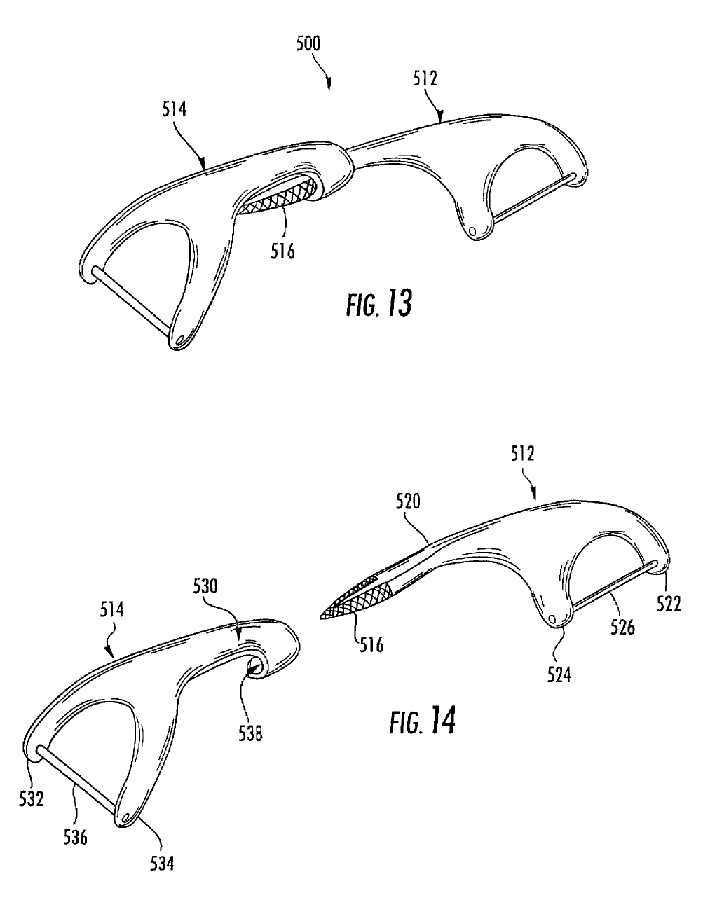

With reference to FIGS. 13 and 14, there is shown another embodiment of a combination flosser pick system 500 having a first flosser 512 and a second flosser 514. The first flosser 512 is configured to include a pick end 516. The second flosser 514 is configured to receive portions of the first flosser 512 to provide the assembled flosser/pick system 500.

The first flosser 512 includes an elongate handle 520, spaced apart arms 522 and 524, with a length of dental floss 526 is secured to and extends between the arms 522 and 524. The second flosser 114 includes an elongate handle 530 having spaced apart arms 532 and 534, with a length of dental floss 536 is secured to and extends between the arms 532 and 534. An end portion of the handle 530 is configured define an elongate aperture shaped receiver 538 configured to permit the pick end 516 of the first flosser 112 to be passed therethrough and frictionally engage an adjacent portion of the handle 520 to provide the assembled flosser/pick system 500. For example, the receiver 538 is sized to frictionally engage a portion of the handle 520 adjacent the smaller diameter of the pick end 516.

The flosser pick systems described herein provide a plurality of flosser devices in combination with a dental pick device in a compact configuration. One advantage of the systems resides in the concealment of the pick end 16 when the systems are in their assembled states. Another advantage relates to the combinations of the first flossers and the second flossers in the compact configurations of the systems. The first flossers and the second flossers may have the same or different configurations to provide different flossing characteristics.

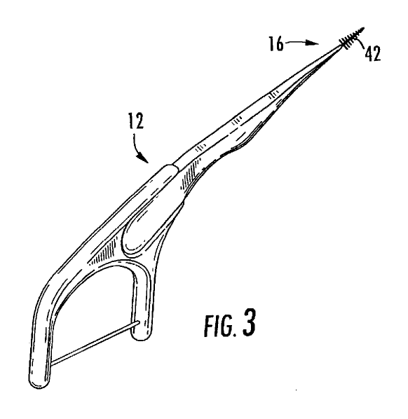

For example, returning to FIGS. 1 and 2, the first flosser 12 described in connection with the system 10 is particularly configured for flossing between teeth located proximate the frontal portions of the mouth. It will be observed that the floss 26 of the first flosser 12 lies in a plane generally parallel to the length axis of the handle 20. Conversely, the second flosser 14 is particularly configured for flossing between teeth located proximate rear portions of the mouth, with the floss 36 extending generally perpendicular to the length axis of the handle 30. It will be understood that the particular configurations of the flosser heads may vary and that the drawings merely depict exemplary embodiments.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A flosser pick system, the system comprising:
a first dental flosser having an elongate handle having a pick end and spaced apart arms at the opposite end with a length of dental floss extending between the arms; and
a second dental flosser having a handle, a pair of spaced apart arms at one end of the handle with a length of dental floss extending between the arms, and a receiver defined as part of second dental flosser and configured to matingly receive portions of the first flosser to provide the flosser pick system.

2. The system of claim 1, wherein the floss of the first flosser has a length that extends substantially parallel to the length of the handle of the first flosser.

3. The system of claim 1, wherein the floss of the second flosser has a length that extends substantially perpendicular to the length of the handle of the second flosser.

4. The system of claim 1, wherein the pick end is tapered to a point.

5. The system of claim 1, wherein the pick end comprises an interdental brush.

6. The system of claim 1, wherein the receiver comprises a cavity provided by a hollow interior portion within the handle of the second dental flosser and being accessible via an open end of the handle of the second dental flosser, and wherein the pick end and a portion of the handle of the first dental flosser adjacent the pick end are fittingly insertable into the cavity via the open end of the handle of the second dental flosser.

7. The system of claim 1, wherein the receiver comprises a pair of spaced apart legs defined on the second flosser, the legs having inwardly facing protrusions configured for frictionally engaging portions of the first flosser.

8. The system of claim 1, wherein the receiver comprises an elongate concavity formed on a surface of the handle of the second flosser.

9. The system of claim 1, wherein the receiver comprises an elongate aperture defined adjacent the handle of the second flosser and configured to permit the pick end of the first flosser to be passed therethrough and frictionally engage an adjacent portion of the handle of the first flosser.
